(19) United States
(12) Patent Application Publication
(10) Pub. No.: US 2026/0268020 A1
(43) Pub. Date: Sep. 10, 2026

(54) INFERENCE SYSTEM, INFORMATION PROCESSING SYSTEM, INFERENCE METHOD, AND RECORDING MEDIUM

(71) Applicant: NEC Corporation, Minato-ku, Tokyo (JP)

(72) Inventors: Daisuke MATSUDA, Tokyo (JP); Yoshiyuki ETOU, Tokyo (JP); Satoru FUJII, Tokyo (JP); Shinjiro YAGI, Tokyo (JP)

(73) Assignee: NEC Corporation, Minato-ku, Tokyo (JP)

(21) Appl. No.: 18/876,242

(22) PCT Filed: Aug. 12, 2022
(86) PCT No.: PCT/JP2022/030711

§ 371 Date: Dec. 18, 2024

(51) Int. Cl. G06F 21/62; G06N 5/04

(52) U.S. Cl. CPC G06F 21/6254; G06N 5/04

(57) ABSTRACT

An inference system according to the present invention includes: a memory configured to store instructions; and one or more processors configured to execute the instructions stored in the memory to: acquire parameters for a plurality of models, the plurality of models being learned in each of a plurality of learning participant servers and being configured to infer a specific event; integrate the plurality of acquired parameters; acquire, from an inference user, analysis data for inferring the specific event; execute inference using the analysis data based on an integrated model in which the plurality of parameters are integrated; and output inferred inference result.

### TECHNICAL FIELD

The present disclosure relates to an inference system, an information processing system, an inference method, and a recording medium.

### BACKGROUND ART

For a model using artificial intelligence (AI) learned in each organization such as a company, there is an approach to share the AI model in each organization.

For example, PTL 1 discloses executing integration process of integrating results of machine learning set in a common portion for each learned model. In addition, PTL 2 discloses that users who have not participated in the federated learning are grouped with the same criteria as the users who have participated in the federated learning, and the group model of each group is distributed to the electronic device of the user belonging to the corresponding group.

### CITATION LIST

### Patent Literature

PTL 1: JP 2020-115311 A

PTL 2: JP 2021-197181 A

### SUMMARY OF INVENTION

### Technical Problem

However, in the invention described in PTL 2 described above, a global model (integrated model) by federated learning is directly transferred to an inference user who is a user, and can be locally used. In this case, there is a problem of the risk of outflow of original data of the integrated model and the AI model being permanently used without restriction.

An example of an object of the present disclosure is to provide a system capable of managing use of an integrated model while preventing outflow of original data of the integrated model to an inference user.

### Solution to Problem

An inference system according to one aspect of the present disclosure includes a parameter acquisition means for acquiring parameters for a plurality of models, the plurality of models being learned in each of a plurality of learning participant servers and being configured to infer a specific event, an integration means for integrating the plurality of acquired parameters, an analysis data acquisition means for acquiring, from an inference user, analysis data for inferring the specific event, an inference means for executing inference using the analysis data based on an integrated model in which the plurality of parameters are integrated, and an output means for outputting inferred inference result.

An inference system according to one aspect of the present disclosure includes a parameter acquisition means for acquiring analysis data for inferring a specific event, an inference means for executing inference regarding the specific event using the analysis data based on an integrated model in which parameters of a plurality of models are integrated by federated learning using secure computation, and an output means for outputting an inferred inference result.

An information processing system according to one aspect of the present disclosure is an information processing system including a plurality of learning participant servers and the inference system described above, wherein each of the learning participant servers includes a model storage means for storing a learned model for performing inference regarding a specific event, an input/output means for inputting, in an obfuscated form, a parameter updated by federated learning using secure computation for the parameter of the stored model, a restoration unit for restoring the input parameter, and an inference means for applying the restored parameter to the stored model to update the model and performing inference regarding the specific event.

An inference method according to one aspect of the present disclosure includes acquiring parameters for a plurality of models, the plurality of models being learned in each of a plurality of learning participant servers and being configured to infer a specific event, integrating the plurality of acquired parameters, acquiring, from an inference user, analysis data for inferring the specific event, executing inference using the analysis data based on an integrated model in which the plurality of parameters are integrated, and outputting inferred inference result.

A recording medium according to one aspect of the present disclosure stores a program that causes a computer to execute processes of acquiring parameters for a plurality of models, the plurality of models being learned in each of a plurality of learning participant servers and being configured to infer a specific event, integrating the plurality of acquired parameters, acquiring, from an inference user, analysis data for inferring the specific event, executing inference using the analysis data based on an integrated model in which the plurality of parameters are integrated, and outputting inferred inference result.

### ADVANTAGEOUS EFFECTS OF INVENTION

An example of an effect of the present disclosure can provide a system capable of managing use of an integrated model while preventing outflow of original data of the integrated model to an inference user.

### BRIEF DESCRIPTION OF DRAWINGS

FIG. 1 is a block diagram illustrating a configuration of an information processing system according to a first example embodiment.

FIG. 2 is a diagram illustrating a hardware configuration in which an inference system according to the first example embodiment is achieved by a computer device and its peripheral device.

FIG. 3 is a flowchart illustrating an operation of an inference process in the first example embodiment.

FIG. 4 is a block diagram illustrating a configuration of an information processing system according to a modified example of the first example embodiment.

FIG. 5 is a flowchart illustrating an operation of information process in a modified example of the first example embodiment.

### EXAMPLE EMBODIMENT

Next, an example embodiment will be described in detail with reference to the drawings.

### First Example Embodiment

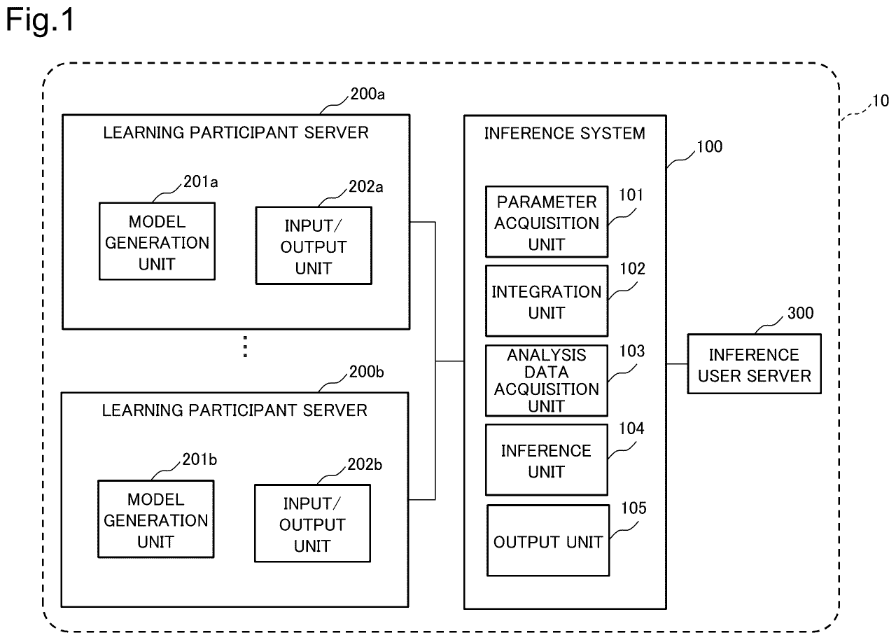

FIG. 1 is a block diagram illustrating a configuration of an information processing system 10 according to a first example embodiment. An information processing system 10 in the first example embodiment is a system for executing inference using analysis data acquired from an inference user by using an integrated model in which parameters of a plurality of models for inferring a specific event held by each learning participant are integrated. Examples of the learning participant include, for example, an organization holding a large number of pieces of learning data for generating a learned model, such as a major company or a major corporation. Examples of the inference user include a small-scale organization that does not hold a large number of pieces of learning data and desires to use inference by an integrated model.

Referring to FIG. 1, the information processing system 10 includes an inference system 100, a plurality of learning participant servers 200 (200a, 200b), and an inference user server 300 held by the inference user. The inference system 100 inputs the analysis data acquired from the inference user to the integrated model to output the inference result related to the event. The specific event is, for example, a matter that can be expressed by a model (mathematical expression) of an arbitrary form. However, the events inferred by the inference system 100 are not limited at all.

The inference system 100 includes a parameter acquisition unit 101, an integration unit 102, an analysis data acquisition unit 103, an inference unit 104, and an output unit 105. Each of the learning participant servers 200 includes a model generation unit 201 (201a, 201b) for generating a model for inferring a specific event, and an input/output unit 202 (202a, 202b) for inputting/outputting parameters to/from the inference system 100. In the present example embodiment, the plurality of learning participant servers 200 are provided at two locations, but the present invention is not limited thereto. The plurality of learning participant servers 200 are provided as many as the number of organizations participating in learning. Hereinafter, the inference system 100 that is an essential configuration of the present example embodiment will be described in detail.

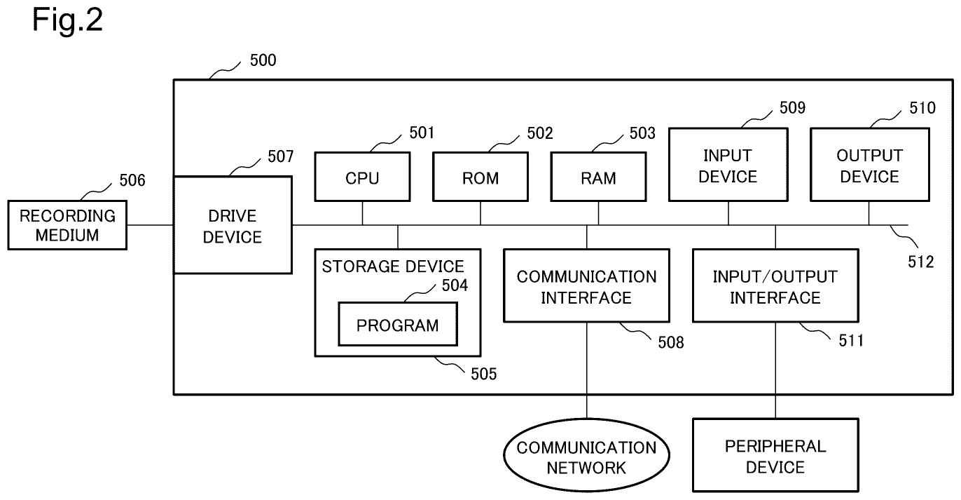

FIG. 2 is a diagram illustrating an example of a hardware configuration in which the inference system 100 according to the first example embodiment of the present disclosure is achieved by a computer device 500 including a processor. As illustrated in FIG. 2, the inference system 100 includes a central processing unit (CPU) 501, a memory such as a read only memory (ROM) 502 and a random access memory (RAM) 503, a storage device 505 such as a hard disk that stores a program 504, a communication interface (I/F) 508 for network connection, and an input/output interface 511 for performing input/output of data. In the first example embodiment, the parameter information received from each learning participant server 200 is input to the inference system 100 via the communication I/F 508.

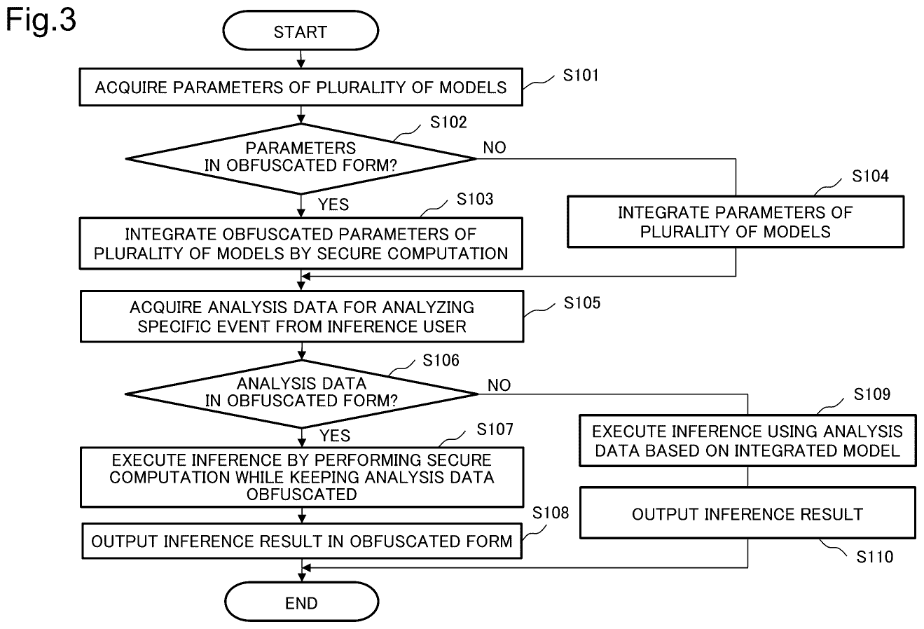

The CPU 501 operates the operating system to control the entire inference system 100 according to the first example embodiment of the present invention. In addition, the CPU 501 reads a program and data from a recording medium 506 mounted on, for example, a drive device 507 to a memory. In addition, the CPU 501 functions as the parameter acquisition unit 101, the integration unit 102, the analysis data acquisition unit 103, the inference unit 104, the output unit 105, and a part thereof in the first example embodiment, and executes a process or a command in the flowchart illustrated in FIG. 3 described later based on a program.

The recording medium 506 is, for example, an optical disk, a flexible disk, a magnetic optical disk, an external hard disk, a semiconductor memory, or the like. A storage medium of a part of the storage device is a non-volatile storage device, and a program is recorded therein. Furthermore, the program may be downloaded from an external computer (not illustrated) connected to a communication network.

The input device 509 is achieved by, for example, a mouse, a keyboard, a built-in key button, and the like, and is used for an input operation. The input device 509 is not limited to a mouse, a keyboard, and a built-in key button, and may be, for example, a touch panel. The output device 510 is achieved by, for example, a display, and is used to confirm an output.

As described above, the first example embodiment illustrated in FIG. 1 is implemented by the computer hardware illustrated in FIG. 2. However, the means for implementing each unit included in the inference system 100 in FIG. 1 is not limited to the configuration described above. Furthermore, the inference system 100 may be achieved by one physically coupled device, or may be achieved by a plurality of devices by connecting two or more physically separated devices in a wired or wireless manner. For example, the input device 509 and the output device 510 may be connected to the computer device 500 via a network. Furthermore, the inference system 100 in the first example embodiment illustrated in FIG. 1 can be configured by cloud computing or the like.

For example, the parameter acquisition unit 101 acquires the parameters of the learned model in each of the plurality of learning participant servers 200 using an operation for integrating the parameters by the service provider providing the inference service as a trigger. The model is, for example, a model learned by machine learning in order to output an inference result regarding a specific event in each learning participant. The model for machine learning includes, but is not limited to, a decision tree model, a linear regression model, a logistic regression model, a neural network model, and the like.

The integration unit 102 integrates the parameters of each model. As a parameter integration method, a known method can be used, and for example, at the time of integration, the weight of the parameter corresponding to each model can be changed according to the feature of each model. For example, the integration unit 102 applies the parameters obtained in this manner to the model and stores the same in the storage device 505.

The parameter acquisition unit 101 may acquire the parameter from each learning participant server 200 in an obfuscated form. In this case, the integration unit 102 integrates the plurality of obfuscated parameters by secure computation. In the present example embodiment, integrating a plurality of obfuscated parameters by secure computation means that the inference system 100 performs machine learning in a state of being distributed to each learning participant server 200 (federated learning) and integrates the parameters of the learned model using secure computation.

As a method of secure computation, special encryption associated to a specific process such as homomorphic encryption, a trusted execution environment in which process is performed in an isolated state on hardware, multi-party computation in which computation process (secure distributed computation) is performed in a state of being secure distributed in a plurality of servers, or the like can be used.

A specific method of the secure computation of the multi-party computation includes the following examples. For example, the obfuscated data a that is a parameter acquired from an arbitrary learning participant server is secure distributed to variance values x1, y1, . . . , and the administrator transmits x1, y1, . . . to different servers. In addition, the obfuscated data b that is a parameter acquired from another learning participant server is secure distributed to variance values x2, y2, . . . , and the administrator transmits x2, y2, . . . to different servers. Next, computation is advanced while communicating with each other in a state where the obfuscated data a and the obfuscated data b are kept in a secure distributed state, and finally the variance values u, v, . . . of the outputs that are the computation results of the respective servers are collected and the restoration process is performed, so that F(a, b) of the computation result is obtained. This computation result is a parameter obtained by integrating parameters of each model. Therefore, in a case where the multi-party computation is used as the secure computation method, the integration unit 102 includes a plurality of servers. According to the multi-party computation, management of an encryption key and an isolated environment are unnecessary, and the computation process is faster. The integration unit 102 restores the parameters of the model obtained in this manner, and stores the model to which the restored parameters are applied in the storage device 505.

The analysis data acquisition unit 103 is a means for acquiring analysis data regarding a specific event from the inference user. The analysis data is, for example, data input to an integrated model for inferring a specific event. For example, the analysis data acquisition unit 103 acquires the analysis data by storing the analysis data in a predetermined server prepared for executing inference from the inference user. The analysis data acquisition unit 103 outputs the acquired analysis data to the inference unit 104.

The analysis data acquisition unit 103 may acquire the analysis data only within a period determined in advance. The period determined in advance is, for example, a period in which the inference user uses the inference service set with the service provider. In this case, a specification may be such that the inference user can access a server for storing analysis data only within a period determined in advance.

The inference unit 104 is a means for executing inference using analysis data based on an integrated model in which a plurality of parameters are integrated. The inference unit 104 inputs analysis data to the integrated model stored in the storage device 505 and executes inference. The inference unit 104 outputs the inferred inference result to the output unit 105.

The output unit 105 is a means for outputting the inferred inference result. The output unit 105 stores the same in a server accessible by the inference user. Furthermore, the output unit 105 may transmit the inferred inference result to the inference user server 300.

The analysis data acquisition unit 103 may acquire analysis data in an obfuscated form from the inference user. In this case, the inference unit 104 executes inference by performing secure computation while keeping the analysis data obfuscated. As a method of secure computation, secure computation similar to the case of integrating the parameters of the model described above can be used. Then, the output unit 105 outputs the inferred inference result to the inference user in an obfuscated form. In this case, the inference user needs to restore the obfuscated inference result.

The operation of the inference system 100 configured as described above will be described with reference to the flowchart of FIG. 3.

FIG. 3 is a flowchart illustrating an outline of an operation of the inference system 100 in the first example embodiment. The processes according to this flowchart may be executed based on a program control by the processor described above. Furthermore, the series of processes according to this flowchart may not be performed continuously, and for example, the integration of parameters in step S101 to step S104 and the inference in steps S105 to S110 in FIG. 3 may be performed at different timings. Furthermore, the inference in steps S105 to S110 may be executed many times, and in that case, the inference may be executed by different inference users.

As illustrated in FIG. 3, first, the parameter acquisition unit 101 acquires a parameter of a learned model for inferring a specific event from each learning participant server 200 (step S101). In a case where the plurality of parameters acquired by the parameter acquisition unit 101 are in the obfuscated form (S102; YES), the integration unit 102 integrates the obfuscated parameters of the plurality of models by secure computation (step S103). On the other hand, in a case where the plurality of parameters acquired by the parameter acquisition unit 101 are not in the obfuscated form (S102; NO), the integration unit 102 integrates the plurality of parameters without using secure computation (step S104).

Next, the analysis data acquisition unit 103 acquires analysis data for inferring a specific event from the inference user (step S105). In a case where the analysis data acquisition unit 103 acquires the analysis data in the obfuscated form from the inference user (S106; YES), the inference unit 104 executes inference by performing secure computation while keeping the analysis data obfuscated based on the integrated model in which the plurality of parameters are integrated. Next, the output unit 105 outputs the inference result by the inference unit 104 in an obfuscated form (step S108). On the other hand, in a case where the analysis data acquisition unit 103 acquires the analysis data not in the obfuscated form from the inference user (S106; NO), the inference unit 104 executes inference using the analysis data based on the integrated model (step S109), and then, the output unit 105 outputs an inference result by the inference unit 104 (step S110). As described above, the inference system 100 ends the inference operation.

In the inference system 100, the inference unit 104 executes inference using the analysis data of the inference user based on an integrated model in which a plurality of parameters are integrated. Therefore, inference can be executed in the inference system 100 without providing the integrated model to the inference user. As a result, it is possible to provide a system capable of managing the use of the integrated model while preventing the outflow of the original data of the integrated model to the inference user.

Furthermore, in the inference system 100, in a case where the plurality of parameters acquired by the parameter acquisition unit 101 are in the obfuscated form, the integration unit 102 integrates the plurality of obfuscated parameters by secure computation. As a result, the integrated model can be used while obfuscating the parameters of each model.

Furthermore, in the inference system 100, in a case where the analysis data acquisition unit 103 acquires the analysis data in the obfuscated form from the inference user, the inference unit 104 executes inference by performing secure computation while keeping the analysis data obfuscated based on the integrated model in which a plurality of parameters are integrated, and the output unit 105 outputs the inference result in the obfuscated format. As a result, it is possible to avoid a risk of leakage of know-how included in the analysis data of the inference user.

Next, applications to which the inference system 100 of the present disclosure is applied will be described. The inference system 100 can be applied to each field such as agriculture, fishery, construction, mobility, finance, education, medical care, healthcare, manufacturing apparatus, and chemistry. Hereinafter, applications of application of the inference system 100 of the present disclosure in each field will be described, but these applications are merely examples of the present disclosure. For example, each learning participant is grouped for each application of the model generated by the learning participant itself, and participates in the federated learning when coinciding with the event inferred by the inference system 100.

In the agricultural field, for example, examples of the learning participant include a major agricultural corporation and a smart agricultural business operator utilizing information and communication technology (ICT), and examples of the inference user include a small and medium agricultural corporation.. Examples of data used for inference of learning data, analysis data, and the like include, for example, room temperature, humidity, weather, carbon dioxide amount, nutrient data of crops, and soil data, and for the application, it is used for growth prediction, control of growth rate and amount, or prediction of diseases. The model used for inference in the inference system 100 is, for example, a model that inputs any one of room temperature, humidity, weather, carbon dioxide amount, nutrient data of crops, and soil data, and outputs growth prediction, control of growth rate or amount, or prediction of diseases.

In the fishery field, for example, examples of the learning participant include a major fishery corporation and a smart fishery business operator utilizing the ICT, and examples of the inference user include a small and medium fishery corporation. Examples of data used for inference include, for example, seawater temperature, weather, fish momentum, food consumption, or fish growth data, and for the application, it is used for growth prediction, control of growth rate, or prediction of diseases. The model used for inference in the inference system 100 is, for example, a model that inputs any one of seawater temperature, weather, fish momentum, food consumption, and fish growth data, and outputs growth prediction, control of growth rate, or prediction of diseases.

In the construction field, for example, examples of the learning participant include a major construction machine manufacturer or a major construction company, and examples of the inference user include a mid-sized construction company or a small and medium-scale construction company. Examples of the data used for the inference include operation data of a construction machine or environmental data of a site, and for the application, for example, it is used for inferring failure prediction, recommendation of man-hour improvement, or influence on environment. The model used for inference in the inference system 100 is, for example, a model that inputs operation data of a construction machine or environmental data of a site and outputs failure prediction, recommendation of man-hour improvement, or influence on the environment.

In the mobility field, for example, examples of the learning participant include a major automobile manufacturer or a map development company, and examples of the inference user include a user (driver) and a transportation business operator. Examples of the data used for inference include road condition data, weather, or traffic information, and for the application, for example, it is used for automatic driving assistance, danger sign, accident prevention, and driver malfunction detection. The model used for inference in the inference system 100 is, for example, a model that inputs any of road condition data, traffic information, and environmental information and outputs a danger sign.

In the financial field, for example, examples of the learning participant include a major bank, and examples of the inference user include a regional bank. Examples of the data used for inference include a transaction history or a customer attribute, and for the application, for example, it is used for inferring anti-money laundering or fraud detection. The model used for inference in the inference system 100 is, for example, a model that inputs the content of a financial transaction such as remittance of a customer and outputs whether it corresponds to fraud such as money laundering.

In the educational field, for example, examples of the learning participant include a major cram school, a prep school, or a communication education business operator, and examples of the inference user include an individual or a small and medium-scale cram school. Examples of the data used for the inference include learning data indicating the learning amount and grade of the student, and for the application, for example, it is used to infer adaptive learning or success rate prediction. The model used for inference in the inference system 100 is, for example, a model that inputs a learning amount and a grade of the target and outputs prediction of the success rate.

In the medical field, for example, examples of the learning participant include a large hospital and a university hospital, and examples of the inference user include a small and medium-scale hospital and a clinic. Examples of the data used for inference include medical information of an electronic health record and image information such as computed tomography (CT) and magnetic resonance imaging (MRI), and for the application, for example, it is used for diagnosis support. The model used for inference in the inference system 100 is, for example, a model that inputs at least one of medical information of an electronic health record, CT image information, and MRI image information of a patient, and outputs a diagnosis result of the patient.

In the manufacturing device field, for example, examples of the learning participant include a manufacturing device manufacturer, and examples of the inference user include a device introducing company. Examples of the data used for inference include operation data or manufacturing information of a device, and for the application, for example, it is used for failure prediction or to improve yield. The model used for inference in the inference system 100 is, for example, a model that inputs operation data of a device and outputs failure prediction.

In the chemical field, for example, examples of the learning participant include a major chemical manufacturer, and examples of the inference user include a small and medium chemical manufacturer. Examples of the data used for inference include analysis/experimental data, and for the application, for example, it is used to improve the efficiency of material development and predict target performance or characteristics. The model used for inference in the inference system 100 is, for example, a model that inputs information regarding a material to be developed and outputs any one of efficiency improvement of material development, target performance, prediction characteristics of the material, and a synthesizing method.

### Modified Example of First Example Embodiment

Next, a modified example of the first example embodiment of the present disclosure will be described in detail with reference to the drawings. Hereinafter, description of contents overlapping with the above description will be omitted to the extent that the description of the present example embodiment does not become unclear. The information processing system 11 in the modified example of the first example embodiment is used to provide each learning participant server with a model updated by federated learning using secure computation. These update models are used, for example, for each learning participant to infer a specific event. Similarly to the computer device illustrated in FIG. 2, each component in each exemplary example embodiment of the present disclosure can implement the function not only by hardware but also by a computer device based on program control.

### <Inference System>

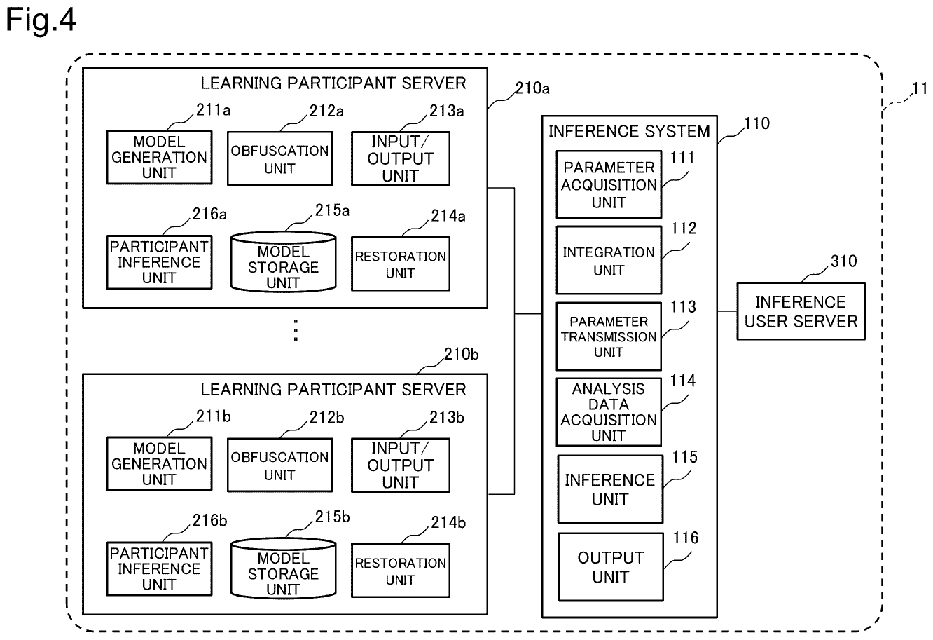

FIG. 4 is a block diagram illustrating a configuration of an information processing system 11 including an inference system 110 according to a modified example of the first example embodiment of the present disclosure. With reference to FIG. 4, an inference system 110, a learning participant server 210 (210a, 210b), and an inference user server 310 according to a modified example of the first example embodiment will be described focusing on portions different from those of the information processing system 10 according to the first example embodiment. The inference system 110 includes a parameter acquisition unit 111, an integration unit 112, a parameter transmission unit 113, an analysis data acquisition unit 114, an inference unit 115, and an output unit 116.

The parameter acquisition unit 111 acquires the parameters of the learned model of each learning participant from the learning participant server 210 through the communication I/F 508. Next, the integration unit 112 integrates the parameters of the received obfuscated model by secure computation, and outputs the integrated parameters of the obfuscated model to the parameter transmission unit 113 in an obfuscated form. The parameter transmission unit 113 transmits the integrated parameters to each learning participant server 210 through the input/output unit 213. Furthermore, in a case where learning of the model is performed again on the learning participant server 210 side and the parameter is updated after transmitting the parameter to the learning participant server 210, the inference system 110 may acquire the updated parameter again. The operations of the analysis data acquisition unit 114, the inference unit 115, and the output unit 116 are similar to the operations of each of the corresponding components in the first example embodiment, and thus the description thereof will be omitted here.

### <Learning Participant Server>

In the modified example of the first example embodiment, the plurality of learning participant servers 210 (210a, 210b) include a model generation unit 211 (211a, 211b), an obfuscating unit 212 (212a, 212b), an input/output unit 213 (213a, 213b), a restoration unit 214 (214a, 214b), a model storage unit 215 (215a, 215b), and a participant inference unit 216 (216a, 216b). The model generated by the model generation unit 211 is stored in the model storage unit 215.

The learning participant server 210 updates the model stored in the model storage unit 215 to a model to which the parameter received from the inference system 110 is applied. Specifically, the input/output unit 213 receives the parameter in the obfuscated form and outputs the parameter to the restoration unit 214. Next, the restoration unit 214 restores the parameter and replaces it with the parameter of the model stored in the model storage unit 215. Next, the participant inference unit 216 performs inference using the updated model. In order to enhance the accuracy of the result of the inference by the participant inference unit 216, the learning participant server 210 may perform learning again based on the additionally obtained learning data and further transmit the updated parameter to the inference system 110. The accuracy of the model can be further enhanced by repeating updating of the parameters by learning in each learning participant server 210 and integration of the parameters in the inference system 110 until, for example, a condition defined in advance is satisfied. The condition defined in advance is stored, for example, in the storage device 505.

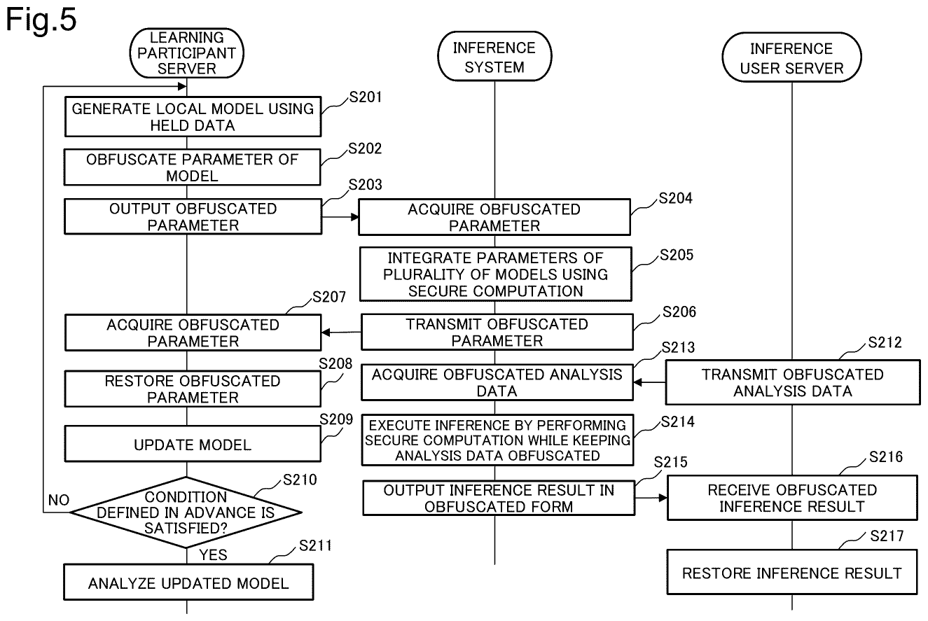

The operation of the information processing system 11 configured as described above will be described with reference to the flowchart of FIG. 5.

FIG. 5 is a flowchart illustrating an outline of an operation of the information processing system 11 according to the first example embodiment. The processes according to this flowchart may be executed based on a program control by the processor described above.

As illustrated in FIG. 5, first, in the learning participant server 210, the model generation unit 211 locally generates a model by using held data of the learning participant (step S201). Next, the obfuscating unit 212 obfuscates the parameter of the model (step S202), and the input/output unit 213 outputs the obfuscated parameter to the inference system 110 (step S203). Next, the parameter acquisition unit 111 of the inference system 110 acquires the obfuscated parameter (step S204). Then, the integration unit 112 integrates the plurality of obfuscated parameters by using secure computation (step S205). Next, the parameter transmission unit 113 outputs the parameters of the model integrated by the integration unit 112 to each of the learning participant servers 210 in an obfuscated form (step S206).

Next, each learning participant server 210 acquires the integrated parameters through the input/output unit 213 in an obfuscated form (step S207). The restoration unit 214 then restores the parameters in the obfuscated form (step S208). Next, the learning participant server 210 updates the model stored in the model storage unit 215 to a model to which the restored parameter is applied (step S209). Next, the learning participant server 210 determines whether a condition defined in advance is satisfied (step S210). In a case where a condition defined in advance is satisfied (step S210; YES), the participant inference unit 216 infers using the updated model (step S211). In a case where the condition defined in advance is not satisfied, the learning participant server 210 returns to step S201 (step S210; NO) and performs the flow again.

On the other hand, in a case of requesting inference regarding a specific event, the inference user server 310 transmits analysis data in an obfuscated form to the inference system 100 (step S212). Next, in the inference system 100, the analysis data acquisition unit 114 acquires the analysis data in the obfuscated form (step S213), the inference unit 115 executes secure computation while keeping the analysis data obfuscated (step S214), and the output unit 116 outputs the inference result to the inference user server 310 in the obfuscated form (step S215).

When receiving the inference result in the obfuscated form (step S216), the inference user server 310 restores the inference result (step S217). Thus, the information processing system 11 ends the operation of information processing.

In a modified example of the first example embodiment of the present disclosure, the participant inference unit 216 of each learning participant server 210 executes inference regarding a specific event using a model to which parameters of the model integrated by the integration unit 112 are applied. As a result, a more accurate inference result can be output in each learning participant server 210.

While the present invention has been described with reference to the respective embodiments, the present invention is not limited to the above embodiments. It will be understood by those of ordinary skill in the art that various changes in form and details may be made therein without departing from the spirit and scope of the present invention as defined by the claims.

In addition, although the plurality of operations are described in order in the form of a flowchart, the order of description does not limit the order of executing the plurality of operations. For example, when each example embodiment is implemented, the order of the plurality of operations can be changed within a range that does not interfere with the content. Specifically, in the flowchart of FIG. 5, after the integration unit 112 in the inference system 110 integrates the parameters, the parameter transmission unit 113 transmits the integrated parameters to the learning participant server 210. However, after the integration unit 112 in the inference system 110 integrates the parameters, the analysis data acquisition unit 114 may first acquire the analysis data from the inference user server 310.

Some or all of the above example embodiments may be described as the following supplementary notes, but are not limited to the following.

### (Supplementary Note 1)

An inference system including:
a parameter acquisition means for acquiring parameters for a plurality of models, the plurality of models being learned in each of a plurality of learning participant servers and being configured to infer a specific event,
an integration means for integrating the plurality of acquired parameters,
an analysis data acquisition means for acquiring, from an inference user, analysis data for inferring the specific event,
an inference means for executing inference using the analysis data based on an integrated model in which the plurality of parameters are integrated, and
an output means for outputting inferred inference result.

### (Supplementary Note 2)

The inference system according to supplementary note 1, wherein
the analysis data acquisition means acquires the analysis data in an obfuscated form from the inference user,
the inference means executes inference by performing secure computation while keeping the analysis data obfuscated, and
the output means outputs the inferred inference result in an obfuscated form.

### (Supplementary Note 3)

The inference system according to supplementary note 1 or 2, wherein
the parameter acquisition means acquires parameters of the plurality of models in an obfuscated form, and
the integration means integrates the plurality of parameters using secure computation.

### (Supplementary Note 4)

The inference system according to any one of supplementary notes 1 to 3, wherein
the analysis data acquisition means acquires the analysis data only within a predetermined period.

### (Supplementary Note 5)

An inference system including:
an analysis data acquisition means for acquiring analysis data for inferring a specific event,
an inference means for executing inference regarding the specific event using the analysis data based on an integrated model in which parameters of a plurality of models are integrated by federated learning using secure computation, and
an output means for outputting an inferred inference result.

### (Supplementary Note 6)

The inference system according to supplementary note 5, wherein
the inference means executes inference by performing secure computation while keeping the analysis data obfuscated.

### (Supplementary Note 7)

The inference system according to any one of supplementary notes 1 to 6, wherein
the model is a model that inputs any one of medical information of an electronic health record, CT image information, and MRI image information of a patient as the analysis data, and outputs a diagnosis result of the patient.

### (Supplementary Note 8)

The inference system according to any one of supplementary notes 1 to 6, wherein
the model is a model that inputs any one of road condition data, traffic information, and environmental information as the analysis data, and outputs a danger sign.

### (Supplementary Note 9)

The inference system according to any one of supplementary notes 1 to 6, wherein
the model is a model that inputs a content of a financial transaction of a customer as the analysis data and outputs whether the input data corresponds to fraud including money laundering.

### (Supplementary Note 10)

The inference system according to any one of supplementary notes 1 to 6, wherein
the model is a model that inputs information regarding a material to be developed as the analysis data and outputs any one of efficiency improvement of material development, target performance, prediction characteristics of the material, and a synthesizing method.

### (Supplementary Note 11)

An information processing system including a plurality of learning participant servers and the inference system according to any one of supplementary notes 1 to 10, wherein
each of the learning participant servers includes a model storage means for storing a learned model for performing inference regarding a specific event,
an input/output means for inputting, in an obfuscated form, a parameter updated by federated learning using secure computation for the parameter of the stored model,
a restoration means for restoring the input parameter, and
a participant inference means for applying the restored parameter to the stored model to update the model and performing inference regarding the specific event.

### (Supplementary Note 12)

An inference method including:
acquiring parameters for a plurality of models, the plurality of models being learned in each of a plurality of learning participant servers and being configured to infer a specific event,
integrating the plurality of acquired parameters,
acquiring, from an inference user, analysis data for inferring the specific event,
executing inference using the analysis data based on an integrated model in which the plurality of parameters are integrated; and
outputting inferred inference result.

### (Supplementary Note 13)

A recording medium for storing a program that causes a computer to execute processes of:
acquiring parameters for a plurality of models, the plurality of models being learned in each of a plurality of learning participant servers and being configured to infer a specific event,
integrating the plurality of acquired parameters,
acquiring, from an inference user, analysis data for inferring the specific event,
executing inference using the analysis data based on an integrated model in which the plurality of parameters are integrated; and outputting inferred inference result.

### REFERENCE SIGNS LIST

10, 11 information processing system
100, 110 inference system
101, 111 parameter acquisition unit
102, 112 integration unit
103, 114 analysis data acquisition unit
104, 115 inference unit
105,116 output unit
113 parameter transmission unit
200, 210 learning participant server
201, 211 model generation unit
202, 213 input/output unit
212 obfuscating unit
214 restoration unit
215 model storage unit
216 participant inference unit
300, 310 inference user server

What is claimed is:

1. An inference system comprising:
a memory configured to store instructions; and
one or more processors configured to execute the instructions to:
acquire parameters for a plurality of models, the plurality of models being learned in each of a plurality of learning participant servers and being configured to infer a specific event;
integrate the plurality of acquired parameters;
acquire, from an inference user, analysis data for inferring the specific event;
execute inference using the analysis data based on an integrated model in which the plurality of parameters are integrated; and
output inferred inference result.

2. The inference system according to claim 1, wherein
the one or more processors are further configured to execute the instructions to:
acquire the analysis data in an obfuscated form from the inference user;
execute inference by performing secure computation while keeping the analysis data obfuscated; and
output the inferred inference result in the obfuscated form.

3. The inference system according to claim 1, wherein
the one or more processors are further configured to execute the instructions to:
acquire parameters of the plurality of models in the obfuscated form; and
integrate the plurality of parameters using secure computation.

4. The inference system according to claim 1, wherein
the one or more processors are further configured to execute the instructions to:
acquire the analysis data only within a predetermined period.

5. An inference system comprising:
a memory configured to store instructions; and
one or more processors configured to execute the instructions to:
acquire analysis data for inferring a specific event;
an execute inference regarding the specific event using the analysis data based on an integrated model in which parameters of a plurality of models are integrated by federated learning using secure computation; and
output an inferred inference result.

6. The inference system according to claim 5, wherein
the one or more processors are further configured to execute the instructions to:
execute inference by performing secure computation while keeping the analysis data obfuscated.

7. The inference system according to claim 1, wherein
the model is a model that inputs any one of medical information of an electronic health record, CT image information, and MRI image information of a patient as the analysis data, and outputs a diagnosis result of the patient.

8. The inference system according to claim 1, wherein
the model is a model that inputs any one of road condition data, traffic information, and environmental information as the analysis data, and outputs a danger sign.

9. The inference system according to claim 1, wherein
the model is a model that inputs a content of a financial transaction of a customer as the analysis data and outputs whether the input data corresponds to fraud including money laundering.

10. The inference system according to claim 1, wherein
the model is a model that inputs information regarding a material to be developed as the analysis data and outputs any one of efficiency improvement of material development, target performance, prediction characteristics of the material, and a synthesizing method.

11. An information processing system comprising a plurality of learning participant servers and the inference system according to claim 1, wherein
each of the learning participant servers store a learned model for performing inference regarding a specific event;
input, in an obfuscated form, a parameter updated by federated learning using secure computation for the parameter of the stored model;
restore the input parameter;
apply the restored parameter to the stored model to update the model; and
perform inference regarding the specific event.

12. An inference method comprising:
acquiring parameters for a plurality of models, the plurality of models being learned in each of a plurality of learning participant servers and being configured to infer a specific event;
integrating the plurality of acquired parameters;
acquiring, from an inference user, analysis data for inferring the specific event;
executing inference using the analysis data based on an integrated model in which the plurality of parameters are integrated; and
outputting inferred inference result.

13. A non-transitory computer-readable recording medium for storing a program that causes a computer to execute processes of:
acquiring parameters for a plurality of models, the plurality of models being learned in each of a plurality of learning participant servers and being configured to infer a specific event;
integrating the plurality of acquired parameters;
acquiring, from an inference user, analysis data for inferring the specific event;
executing inference using the analysis data based on an integrated model in which the plurality of parameters are integrated; and
outputting inferred inference result.
